(19) United States
(12) Patent Application Publication
(10) Pub. No.: US 2024/0393526 A1
(43) Pub. Date: Nov. 28, 2024

(54) ANTI-REFLECTION SURFACE VIA METHODS OF LASER ANNEALING OF MASKING LAYER ON FIBER OPTIC TIP

(71) Applicant: The University of North Carolina at Charlotte, Charlotte, NC (US)

(72) Inventors: Thomas Clifton Hutchens, Charlotte, NC (US); Ishwar D. Aggarwal, Charlotte, NC (US); Benjamin A. Vaca, Charlotte, NC (US)

(73) Assignee: The University of North Carolina at Charlotte, Charlotte, NC (US)

(21) Appl. No.: 18/675,430

(22) Filed: May 28, 2024

Related U.S. Application Data
(60) Provisional application No. 63/469,123, filed on May 26, 2023.

(51) Int. Cl. G02B 6/02; B82Y 20/00; B82Y 40/00; C03C 25/6293; C03C 25/68

(52) U.S. Cl. CPC G02B 6/0229; B82Y 20/00; B82Y 40/00; C03C 25/6293; C03C 25/68

(57) ABSTRACT

Disclosed are methods of and systems for creating an anti reflection structure surface (ARSS) on a fiber optic tip, as well as fiber optic tips themselves. A representative method can comprise providing a fiber optic having a first tip at a first end of the fiber optic and a second tip at a second end of the fiber optic opposite the first end of the fiber optic, each of the first and second tip having an end face; disposing a layer of masking material on a surface of the end face of one of the fiber optic tips; exposing the layer of masking material to a laser to form one or more metal islands of the surface of the fiber optic tip; and etching the surface to provide one or more anti reflection structures on the surface of the fiber optic tip.

### CROSS-REFERENCE TO RELATED APPLICATIONS

This application claims priority to and the benefit of U.S. Provisional Patent Application Ser. No. 63/469,123, filed May 26, 2023, the disclosure of which is incorporated herein by reference in its entirety.

### GOVERNMENT SUPPORT CLAUSE

This invention was made with government support under award no. 2052745 awarded by National Science Foundation. The government has certain rights in the invention.

### TECHNICAL FIELD

The subject matter disclosed herein relates generally to the field of optics and anti-reflection surfaces. More particularly, the subject matter disclosed herein relates to methods and systems for making fiber optic tips having an anti reflection structure surface (ARSS) and fiber optic tips having an ARSS.

### BACKGROUND

Photolithographic equipment designed for semiconductor and wafer processing is not suited for fiber optic tips. Further, randomly sputtered coatings typically have very small feature sizes (5-25 nm), much smaller than the desired feature dimensions of ARSS on a fiber (˜500-1000 nm). Thus, approaches for forming ARSS on fiber optic tips remain an ongoing and unmet need in the art.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, the presently disclosed subject matter provides a method of creating an anti reflection structure surface (ARSS) on a fiber optic tip. In some embodiments, the method comprises providing a fiber optic having a first tip at a first end of the fiber optic and a second tip at a second end of the fiber optic opposite the first end of the fiber optic, each of the first and second tip having an end face; disposing a layer of masking material on a surface of the end face of one of the fiber optic tips; exposing the layer of masking material to a light source to form one or more islands of masking material on the surface of the end face of the fiber optic tip; and etching the surface to provide one or more anti reflection structures on the surface of the end face of the fiber optic tip.

In some embodiments, the masking material comprises a metal. In some embodiments, disposing the layer of metal on a surface of a fiber optic tip comprises sputtering metal nanoparticles on the surface of the fiber optic tip. In some embodiments, the metal is selected from the group consisting of a noble metal and a transition metal. In some embodiments, the metal layer has a thickness ranging from about 1 nanometer (nm) to about 20 nm.

In some embodiments, the light source is a laser or incoherent light source. In some embodiments, the light source is selected from the group consisting of a diode laser, a NdYAG laser, a Ytterbium fiber laser, and a tungsten lamp. In some embodiments, the laser is operated at a power level ranging from about 0.5 watts (W) to about 10W.

In some embodiments, exposing the layer of making material to a laser comprises directing the light source to the layer of masking material from an opposite surface of the surface of the endface of the fiber optic upon which the layer of masking material is disposed. In some embodiments, exposing the layer of metal to a laser comprises directing the light source to the layer of masking material from the opposite endface of the fiber optic. In some embodiments, the laser is coupled to one end of the fiber optic. In some embodiments, the laser is coupled into the opposite end of the fiber from the end of the fiber optic upon which the layer of masking material is disposed.

In some embodiments, the method comprises removing the one more islands of masking material.

In some embodiments, the one or more structures each have a preselected dimension based a preselected performance characteristic for the fiber optic. In some embodiments, the preselected dimension corresponds to a preselected apparent gradient refractive index. In some embodiments, the fiber optic performance characteristic is operation at a near-infrared wavelength and/or at a mid-infrared wavelength. In some embodiments, the preselected dimension of the one or more structures is an aspect ratio width: depth of 1:1 to 1:5. In some embodiments, the preselected dimension of the one or more structures is a width less than or equal to about 500 nm and/or a depth greater than or equal to about 750 nm.

In some embodiments, the fiber optic comprises a material selected from the group consisting of silica, a doped fiber, a gain media fiber, a polycrystalline material, and a single crystal material. In some embodiments, fiber optic has a core diameter ranging from about 5 microns to about 1000 microns.

In some embodiments, the etching comprises plasma etching. In some embodiments, the plasma etching is fluorine based or fluorine and chlorine based. In some embodiments, the method further comprises repeating each step on the opposite tip at the opposite end of the fiber optic, to provide one or more anti reflection structures on the end face of the opposite tip of the fiber optic.

In some embodiments, a fiber optic produced by the presently disclosed methods is provided. In some embodiments, a laser system comprising produced by the presently disclosed methods is provided

In some embodiments, a fiber optic having a tip having one or more anti reflection structures on an endface of the fiber optic tip is provided. In some embodiments, the one or more structures each have a preselected dimension based a preselected performance characteristic for the fiber optic to provide an ARSS on the fiber optic tip. In some embodiments, the preselected dimension corresponds to a preselected apparent gradient refractive index. In some embodiments, the fiber optic performance characteristic is operation at a near-infrared wavelength and/or at a mid-infrared wavelength. In some embodiments, the preselected dimension of the one or more structures is an aspect ratio width: depth of 1:1 to 1:5. In some embodiments, the preselected dimension of the one or more structures is a width less than or equal to about 500 nm and/or a depth greater than or equal to about 750 nm. In some embodiments, a laser system comprising the fiber optic is provided.

In some embodiments, a system for creating an anti reflection structure surface (ARSS) on a fiber optic tip is provided. In some embodiments, the system comprises a dispenser for disposing a layer of masking material on a surface of an end face of a fiber optic tip; a laser for dewetting the layer of masking material to a laser to form one or more islands of the surface of the fiber optic tip; and a component for etching the surface to provide one or more anti reflection structures on the surface of the fiber optic tip. In some embodiments, the system comprises a coupler for coupling the laser to a fiber optic. In some embodiments, the system comprises a component for removing the masking material. In some embodiments, the component for etching the surface and the component for removing the masking material are the same component. In some embodiments, the system comprises a controller for operating the dispenser, the laser, the component for etching the surface and/or the component for removing the masking material.

Accordingly, it is an object of the presently disclosed subject matter to provide fiber optic tips having an anti reflection structure surface (ARSS) and methods for preparing the same. An object of the presently disclosed subject matter having been stated hereinabove, and which is achieved in whole or in part by the presently disclosed subject matter, other objects will become evident as the description proceeds when taken in connection with the accompanying figures as best described hereinbelow.

### BRIEF DESCRIPTION OF THE FIGURES

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the following drawings in which:

FIG. 1 is a photographic image of a SubMiniature version A (SMA) connectorized fiber optic patch cable with an optic end, referred to as Endface A (in dashed line square) and a second end, referred to as Endface B.

FIG. 2 is a schematic diagram showing a cross-sectional view of Endface A of the SubMiniature version A (SMA) connectorized fiber shown in FIG. 1. The fiber optic tip of Endface A is shown in the dashed line square.

FIG. 3 is a schematic diagram showing a cross-sectional view of the optic tip of Endface A shown in FIGS. 1 and 2.

FIG. 4 is a schematic diagram showing gold nanoparticles being sputtered onto the fiber optic tip of Endface A shown in FIG. 3.

FIG. 5 is a schematic diagram showing a cross-sectional view the fiber optic tip of Endface A shown in FIG. 3 after the sputtering shown in FIG. 4 covered with a thin layer of gold over the fiber tip. The fiber tip is shown in the dashed line square.

FIG. 6 is an enlarged schematic diagram showing a cross-sectional view of the gold layer covered fiber tip shown in FIG. 5. The gold layer has a thickness of 1 to 20 nanometers (nm).

FIG. 7 is a combination photographic image/schematic diagram of a SubMiniature version A (SMA) connectorized fiber optic patch cable like that shown in FIG. 1 but with the optic end referred to as Endface A having a thin metal (e.g., gold) layer coating.

FIG. 8 is a combination photographic image/schematic diagram of the SubMiniature version A (SMA) connectorized fiber optic patch cable shown in FIG. 7 with a laser coupled into Endface B.

FIG. 9 is a schematic diagram showing a cross-sectional view of a metal (e.g., gold) layer covered fiber tip of the fiber optic patch cable of FIG. 8 with laser illumination (indicated by the arrows) coming from the trunk fiber, coupled source on Endface B.

FIG. 10 is a schematic diagram showing a cross-sectional view of a fiber tip of the fiber optic patch cable where, upon laser illumination from the trunk fiber, the thin metal (e.g., gold) layer of FIG. 9 on the fiber optic surface dewets, or forms beads, due to heating from the laser and absorption by gold.

FIG. 11 is a schematic diagram showing the top view of the fiber tip shown in FIG. 10.

FIG. 12 is a schematic diagram showing a cross-sectional view of the fiber tip of FIG. 10 and plasma etching of the fiber tip surface using the metal (e.g., gold) beads as an etch mask.

FIG. 13 is a schematic diagram showing a cross-sectional view of the fiber tip of FIG. 10 after plasma etching of the fiber tip surface using the metal (e.g., gold) beads as an etch mask.

FIG. 14 is a schematic diagram showing a cross-sectional view of the fiber tip of FIG. 13 after depletion of the metal (e.g., gold) beads. The etched fiber tip has a structure surface that acts as an apparent gradient-refractive-index and anti-reflection.

FIG. 15 shows a photographic image of a SubMiniature version A (SMA) connectorized fiber optic patch cable with an optic end, referred to as Endface A (in dashed line square) and a second end, referred to as Endface B, where Endface A has an anti-reflective structured surface fabricated using plasma etching after laser dewetting of an etch mask. An enlarged schematic cross-sectional view of etched Endface A is shown at the bottom of the figure.

FIG. 16 is a schematic diagram of a system for creating an anti reflection structure surface (ARSS) on a fiber optic tip in accordance with the presently disclosed subject matter.

FIG. 17 is set of schematic diagrams of a fiber optic having an ARSS in accordance with the presently disclosed subject matter and a laser system comprising a fiber optic having an ARSS in accordance with the presently disclosed subject matter.

FIG. 18 is a flow diagram setting out a representative method of the presently disclosed subject matter.

### DETAILED DESCRIPTION

In accordance with some embodiments of the presently disclosed subject matter, methods of creating an anti reflection structure surface (ARSS) on a fiber optic tip are disclosed. In some embodiments, the methods employ metal islands as etching masks. ARSS has a high damage threshold and can be used for high power laser applications, and high energy fiber laser system, conduit, and fiber laser itself. In some embodiments, disclosed are new processes using the creation of the metal islands on the fiber optic tip, via laser annealing, including but not limited to the use of a laser to dewet a layer of nanoparticles on the opposite endface of a fiber optic cable. The subsequent step of plasma etching can then be performed to create the ARSS. One exemplary benefit of this method is that temperatures to dewet a metal layer can exceed 300° C. Such conditions are typically not suitable for an entire fiber assembly in an annealing oven. In some embodiments, this laser technique focuses the heating to specifically a nano layer of a masking material, such as a metal.

The presently disclosed subject matter now will be described more fully hereinafter in the following detailed description, in which some, but not all embodiments of the presently disclosed subject matter are described. Indeed, the presently disclosed subject matter may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the presently disclosed subject matter. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise indicated, all numbers expressing quantities of length, diameter, width, and so forth used in the specification and claims are to be understood as being modified in all instances by the terms “about” or “approximately”. Accordingly, unless indicated to the contrary, the numerical parameters set forth in this specification and attached claims are approximations that can vary depending upon the desired properties sought to be obtained by the presently disclosed subject matter.

As used herein, the terms “about” and “approximately,” when referring to a value or to a length, width, diameter, temperature, time, volume, concentration, percentage, etc., is meant to encompass variations of in some embodiments±20%, in some embodiments±10%, in some embodiments ±5%, in some embodiments±1%, in some embodiments±0.5%, and in some embodiments±0.1% from the specified amount, as such variations are appropriate for the disclosed apparatuses and devices.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise defined, all terms (including technical and scientific terms) used herein have the same meaning as commonly understood by one having ordinary skill in the art to which the presently disclosed subject matter belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the presently disclosed subject matter, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the presently disclosed subject matter and the claims.

ARSS can be formed on a glass surface via dry plasma etching with an etch resistant masking layer. The layer can be formed via photolithography or randomly sputtered metal/material on the surface prior to plasma etching. The size and composition of the masking layer features can determine the final structures on the glass surface, particularly the lateral dimensions. Photolithographic equipment designed for semiconductor and wafer processing is generally not suited for fiber optic tips, so a random sputter masking is more feasible. Randomly sputtered coatings however typically have very small feature sizes (about 5 nm to about 25 nm), much smaller than the typically desired feature dimensions of ARSS on a fiber (about 500 to about 1000 nm).

A sputter and annealing method can be used to dewet or form the sputtered metal layer into larger islands, of the size needed for plasma etching for near-infrared performance. An optical surface, such as on fused silica windows, can be sputtered with metal, then placed in an oven to anneal at temperatures of about 300° C. to about 700° C.

Dewetting or annealing of metal layer on a window has been used to create a mask for ARSS fabrication. This is performed in an oven or heat lamp. An is the use of a laser through a fiber to do the heating on the opposite surface, and not expose the entire fiber optic assembly to an oven.

### Representative Embodiments of the Presently Disclosed Subject Matter

Referring now to the Figures, wherein like reference numbers refer to like features throughout, the use of a laser positioned at one endface of a fiber optic cable to dewet a layer of nanoparticles on the opposite endface of a fiber optic cable is shown. Other embodiments presented herein include dewetting by focusing on the same side as the deposited layer on the fiber and repeating again, on second fiber endface.

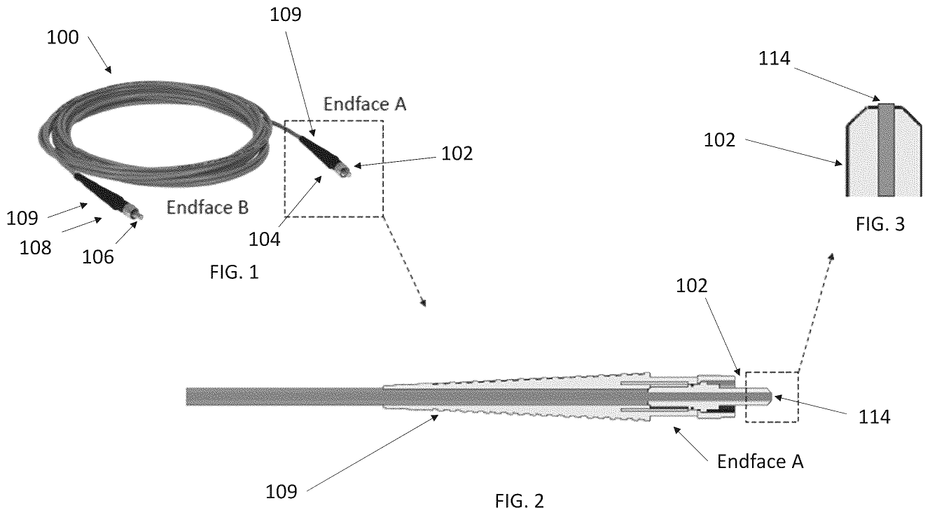

Thus, in some embodiments, the presently disclosed subject matter provides a method of creating an anti reflection structure surface (ARSS) on a fiber optic tip. Referring to FIGS. 1-3, in some embodiments, provided is a fiber optic 100 having a first tip 102 at a first end 104 of the fiber optic 100 and a second tip 106 at a second end 108 of the fiber optic 100 opposite the first end 104 of the fiber optic 100. Each of the first and second tip 102, 106 have an end face, referred to in the Figures as Endface A and Endface B. In some embodiments, the fiber optic 100 is an SMA connectorized fiber optic patch cable. Representative patch cables are commercially available from Thorlabs Inc., Newton, New Jersey, United States of America. Thus, the fiber optic 100 includes a coupler 109 for a laser.

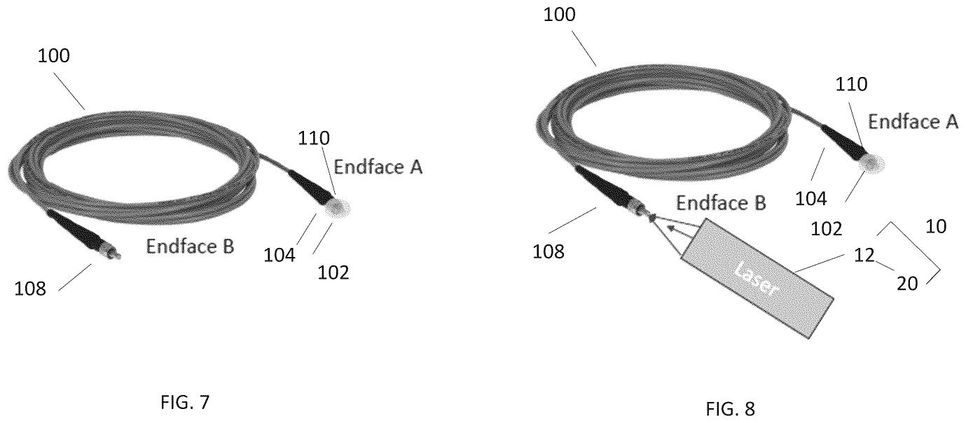

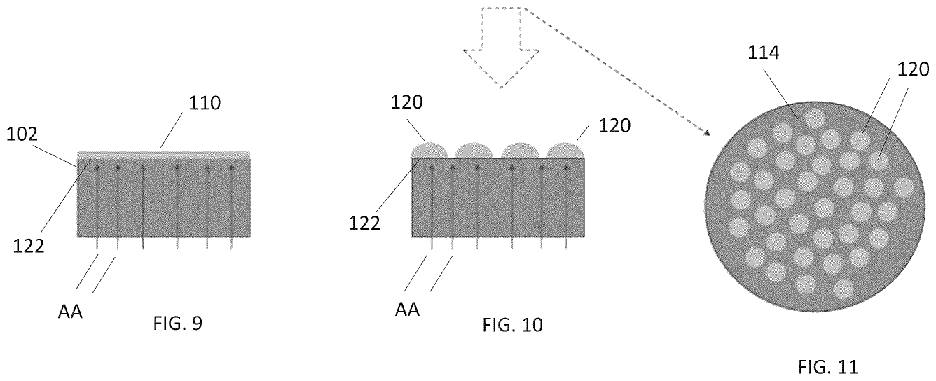

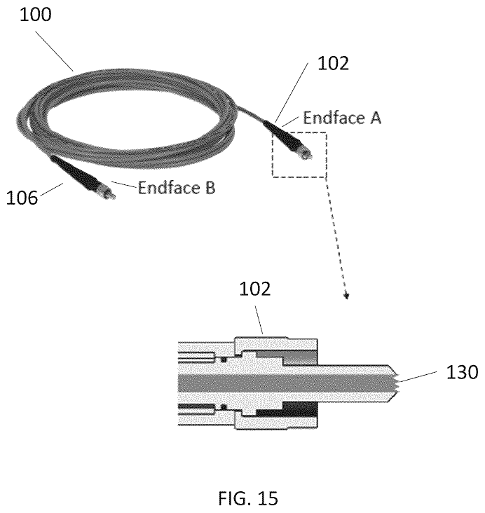

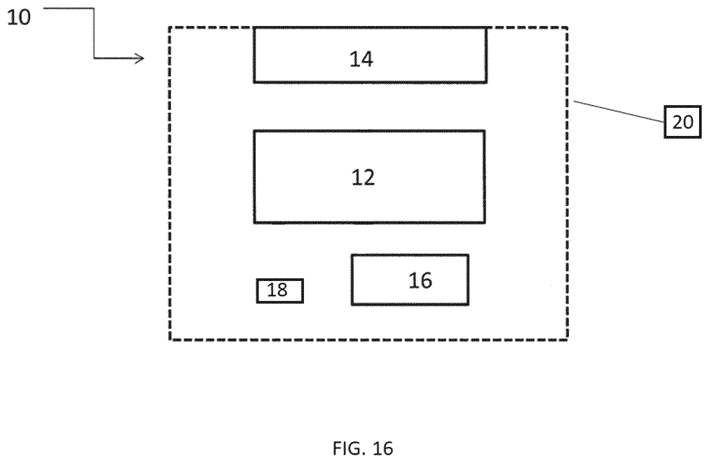

Referring to FIGS. 1-16, a system 10 for creating an anti reflection structure surface (ARSS) 130 on a fiber optic tip 102 of fiber optic 100 is schematically illustrated. In some embodiments, system 10 comprises a dispenser 14 for disposing a layer 110 of masking material on a surface 114 of an tip 102 of a fiber optic 100. System 10 further comprises a light source (e.g., laser) 12 for dewetting the layer 110 of masking material 112 to form one or more islands 120 of the surface 114 of the fiber optic tip 102, System 10 comprises a component 16 for etching the surface 114 to provide one or more anti reflection structures 128 on the surface 114 of the fiber optic tip 102. In some embodiments, system 10 comprises a component 18 for removing masking material 112. In some embodiments, component 16 for etching the surface and component 18 for removing the masking material are the same component. System 10 can further comprise a coupler 109 for coupling the light source 12 to a fiber optic 100. In some embodiments, system 10 comprises a controller 20 operatively connected for operating the dispenser 14, the light source 12, the component 16, and/or the component 18. Controller 20 can be any suitable control device as would be apparent to one of ordinary skill in the art upon a review of the instant disclosure, including but limited to a computer or smart device programmed with suitable instructions for controlling processor parameters as disclosed herein and as would be apparent to one of ordinary skill in the art upon a review of the instant disclosure. For example, computer/electronic controller 20 can include a suitable user input device (e.g., keyboard, touchscreen, etc.) which enables the operator to input selections (materials, pressures, times, locations, etc.) to carry out disposing masking material to regions of the surface of the fiber optic tip; controlling light application to the surface; etching the surface of the fiber optic tip; and removing the masking material. A memory (e.g., non-volatile RAM/ROM, etc.) can be used to store pertinent data, algorithms, look-up tables, matrices, etc.) which the computer/electronic controller 20 uses to carry out and monitor the process of creating the ARSS.

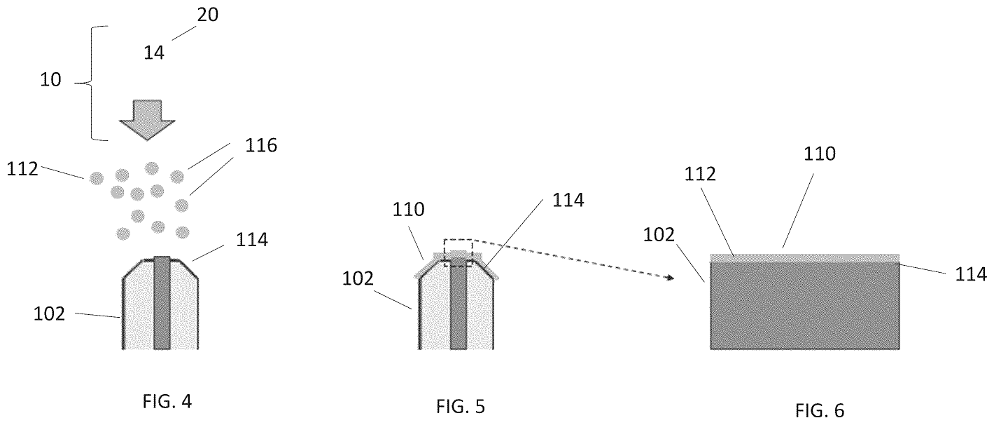

Referring now to FIGS. 4-7, a layer 110 of a masking material 112 is disposed on a surface 114 of the Endface A of one of the fiber optic tips 102 using a dispenser 14, which can be a deposition chamber. In some embodiments, the masking material dewets into islands and has high etch selectivity, such as is a metal masking material. In some embodiments, the metal comprises a noble metal or a transition metal. In some embodiments, the metal is selected from the group comprising gold, platinum, aluminum, nickel, chromium, and combinations thereof. In some embodiments, the metal layer has a thickness ranging from about 1 nanometer (nm) to about 20 nm, including 2, 3, 4, 5, 6, 7, 8, 9, 10, 11, 12, 13, 14, 15, 16, 17, 18, 19, and 20 nm. In some embodiments, disposing the layer 110 of metal on a surface 114 of a fiber optic tip 102 comprises sputtering metal nanoparticles 116 on the surface 114 of the fiber optic tip 102. Any suitable dispenser for disposing the masking material on the surface as would be apparent to one of ordinary skill in the art can be employed in accordance with the presently disclosed subject matter. By way of example and not limitation, a DC sputtering chamber commercially available from AJA International, Inc., Hingham, Massachusetts, United States of America, can be employed. In some embodiments, the sputtering occurs at a pressure ranging from about 1 millitorr (mT) to about 10 mT and over a time ranging from about 10 seconds (sec) to about 120 sec.

Referring now to FIGS. 8-11, the layer 110 of masking material 112 is exposed to a light source 12. In some embodiments, the light source 12 is a laser or an incoherent light source. In some embodiments, one or more islands 120 of masking material 112 are formed on the surface 114 of the End face A of the fiber optic tip 102. Thin layer 110 of masking material (e.g., gold) on fiber optic surface 114 with laser illumination coming from trunk fiber, coupled light source (e.g., laser) 12 on Endface B. Thin layer 114 (e.g., comprising gold) on fiber optic surface dewets, or forms islands beads 120, due to heating from laser 12 and absorption by the masking material comprising layer 114, e.g., gold.

In some embodiments, the light source 12 has any suitable wavelength that the fiber optic 100 can transmit. By way of example and not limitation, the wavelength ranges from ultraviolet (UV) to infrared (IR). In some embodiments, the wavelength ranges from about 300 nm to about 2500 nm. In some embodiments, the wavelength is 532 nm. In some embodiments, the light source is a laser or is an incoherent light source. In some embodiments, the light source is selected from the group comprising a diode laser, a NdYAG laser, a Ytterbium fiber laser, and a tungsten lamp. In some embodiments, the laser is operated at a power level ranging from about 0.5 watts (W) to about 10W. In a particular embodiment, the laser is operated at >5 kW/cm2 (˜0.5W 100 um core). In some embodiments, the light source, e.g., laser provides a fiber tip temperature ranging from about 200° C. to about 700° C. The presently disclosed subject matter facilitates the avoidance of feedback and/or back reflection in a laser. Higher power lasers can be used, as can multiple lasers in one package. A wide bandwidth of lasers can be used. The fiber can be chosen so that many colors of light can pass through it.

In some embodiments, the light source (e.g., laser) 12 is directed (shown by arrows AA) to the layer 110 of masking material from an opposite surface 122 of the surface 114 of the Endface A of the fiber optic tip 102 upon which the layer 110 of masking material is disposed. In some embodiments, the laser is directed (shown by arrows AA) to the layer of masking material from the opposite Endface B of the fiber optic 100. In some embodiments, the laser can also be used while the opposite tip with the masking material (e.g., metal) is still in the deposition system.

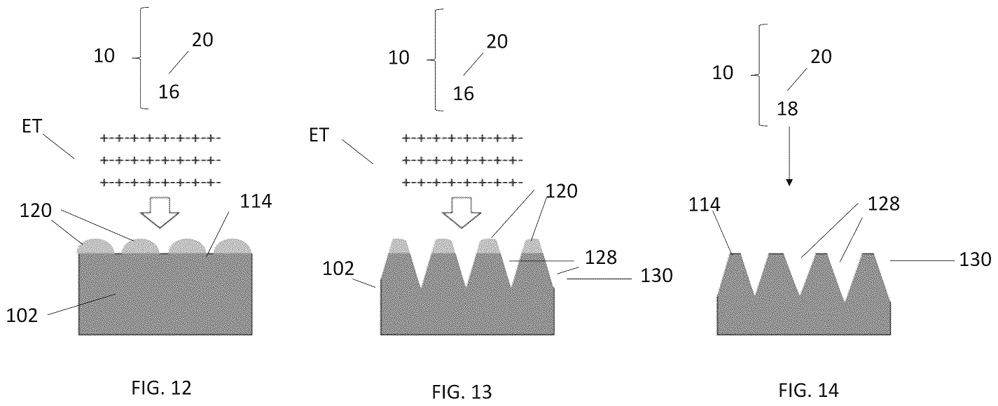

Referring now to FIGS. 12-15, an ARSS 130 comprising one or more structures 128 is formed on a fiber optic tip 102, using the metal islands 120 as an etching mask, and removing the metal islands 120. By way of example and not limitation, as show in FIGS. 12-15, Endface A is etched by etching ET of fiber tip surface 102 using metal (e.g., gold) islands 120 (or beads) as an etch mask. In some embodiments, the etching is by any suitable approach as would be apparent to one of ordinary skill in the art upon a review of the instant disclosure, such as but not limited to plasma etching. For silica figures, plasma etching can be a preferred approach. Other patterning approaches can be employed, including stamping. A suitable patterning approach to control spacing between the islands is employed, as would be apparent to one of ordinary skill of the art upon a review of the present disclosure. In some embodiments, the plasma etching is fluorine based, but can be fluorine and chlorine based for some crystalline fibers. Non-limiting examples of fluorine based compositions employed in the etching process includes CHF₃, SF₆, C₄F₈, CF₄, O₂, Ar. In some embodiments, the etching is carried out at a power level ranging from about 100W to about 1000W; at a pressure ranging from about 10 mT to about 100 mT; and for a time ranging from about 3 minutes to about 30 minutes. In some embodiments, representative components and approaches for etching include but are not limited to reactive ion etching, inductively coupled plasma, or ion milling components and approaches. See also U.S. Pat. No. 11,294,103 B2 to Feigenbaum et al., and Published U.S. Patent Application Ser. No. US 2023/0204820 to Ray et al.

The result is structured surface 130 that acts as an apparent gradient-refractive-index and anti-reflection. After plasma etching of fiber tip surface 102, the metal islands 120 are depleted or removed, by any suitable approach as would be apparent to one of ordinary skill in the art up on a review of the instant disclosure, such as by the use of a potassium iodide solution. In some embodiments, representative components and approaches for depleting or removing the islands include but are not limited to reactive ion etching, inductively coupled plasma, or ion milling components and approaches. See also U.S. Pat. No. 11,294,103 B2 to Feigenbaum et al., and Published U.S. Patent Application Ser. No. US 2023/0204820 to Ray et al.

In some embodiments, each step on the opposite tip at the opposite end of the fiber optic, to provide one or more anti reflection structures on the end face of the opposite tip of the fiber optic.

In some embodiments, the fiber optic comprises a material selected from the group comprising silica, a doped fiber (e.g., doped with a rare earth metal), a gain media fiber, a polycrystalline material, and a single crystal material. In some embodiments, the fiber optic has a core diameter ranging from about 5 microns to about 1000 microns. Bare fiber can be used.

Thus, in some embodiments, the presently disclosed subject matter provides a fiber optic having a tip having one or more anti reflection structures on an endface of the fiber optic tip. In some embodiments, the one or more structures each have a preselected dimension based a preselected performance characteristic for the fiber optic to provide an ARSS on the fiber optic tip. In some embodiments, the preselected dimension corresponds to a preselected apparent gradient refractive index. In a true gradient refractive index, material properties actually change with depth, different doping concentrations in glass for instance. In accordance with the presently disclosed subject matter, the preselected dimension corresponds to an apparent gradient refractive index, in that it acts like a gradient refractive index if features are subwavelength to operating wavelength. The average density of the layer is changing from air, to partial air/glass, to glass. In some embodiments, the fiber optic performance characteristic is operation at a near-infrared wavelength and/or at a mid-infrared wavelength. Deeper features provide better optical performance as the effective apparent gradient refractive index transition the light wave experiences is longer. In some embodiments, the preselected dimension of the one or more structures is an aspect ratio width: depth of 1:1 to 1:5. In some embodiments, the preselected dimension of the one or more structures is a width less than or equal to about 500 nm and/or a depth greater than or equal to about 750 nm. The size and composition of the masking layer features typically determine the final structures on the glass surface, particularly the lateral dimensions.

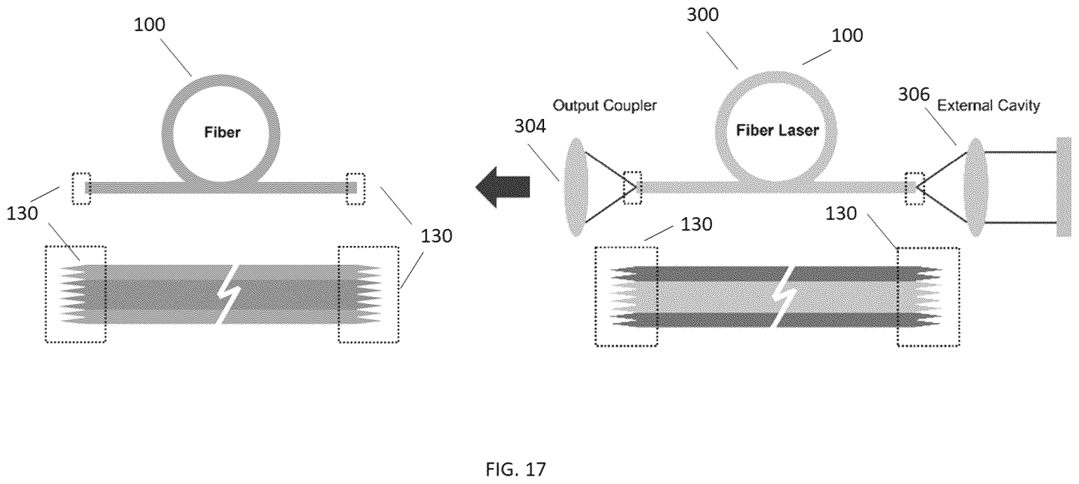

ARSS has a high damage threshold and can be used for high power laser applications, and high energy fiber laser system. Referring to FIG. 17, the presently disclosed subject matter provides a laser system 300 comprising a fiber optic 100 comprising an ARSS 130 as described herein. The system 300 can include a an output coupler 304 and an external cavity 306. The left side of FIG. 17 provides a single standalone fiber optic 100, comprising ARSS 130, used for transmitting light. The right side of FIG. 17 illustrates a fiber laser system 300, fiber optic 100 with ARSS 130 is the gain medium of the laser cavity 306. Also, multiple lasers can be included in one package. In some embodiments, the fiber can be created or tuned with regard to the spectral output of the fiber for low power applications, such as by leaving the islands on the tip.

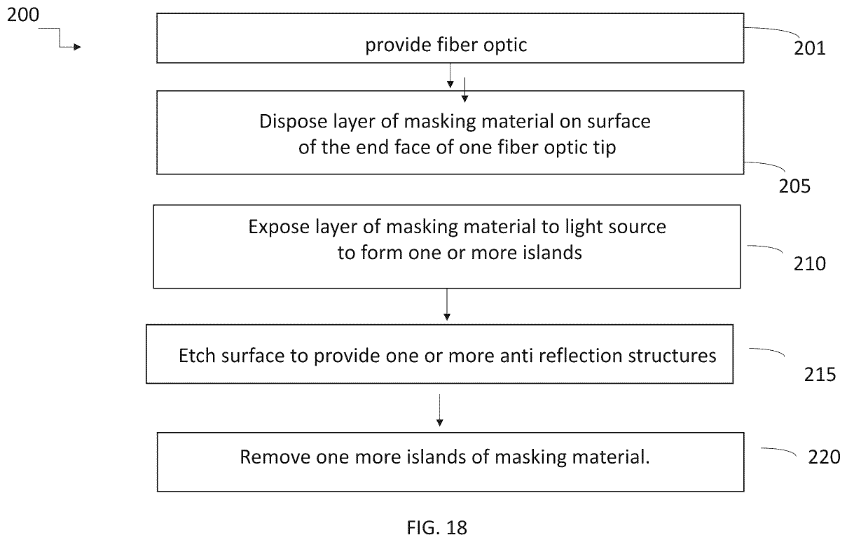

Referring to FIG. 18, a representative method of the presently disclosed subject matter is presented. Method 200 can comprise as step 201 providing a fiber optic; as step 205, disposing a layer of masking material on surface of the end face of one fiber optic tip; as step 210, exposing a layer of masking material to a light source to form one or more islands; as step 215, etching a surface to provide one or more anti reflection structures; and as step 220, removing one more islands of masking material.

### Non-Limiting Examples

In some embodiments, the presently disclosed subject matter provides methods for creating an anti-reflective structured surface (ARSS) on the fiber tip, in some embodiments, through the use of a masking method where laser light through the fiber itself is used to heat/anneal the masking layer.

In some embodiments, if the fiber optic performance is desired to be in the 1500 nm regime (Near-Infrared), to reduce scattering the ARSS feature widths need to be less than ˜1000 nm, and depth greater than ˜750 nm. Deeper features provide better optical performance as the effective apparent gradient refractive index transition the light wave experiences is longer. However, too deep and the ARSS structures become mechanically unstable. Aspect ratios width: depth of 1:1 to 1:5 are desirable. At the micron scale this is a much higher aspect ratio than a machine roughened surface, an aspect of why anisotropic plasma etching is employed.

In some embodiments, (see, e.g., FIGS. 8-11) an annealing step is performed for the etch mask on a fiber optic tip, without exposing the entire trunk fiber, connectorized or not, to the extreme temperatures of an annealing oven. This step is instead performed by illuminating the fiber tip surface with a laser to induce heating and deweting to form islands from the sputtered layer. This can be performed by laser coupling into the opposite end of the fiber. Therefore, instead of heating the entire fiber cable and apparatus only the fiber tip is heated, to dewet the mask. Then the surface is plasma etched to form ARSS.

### EXAMPLES

Fiber Optic: Material: Silica, others. Core diameter: 5-1000 micron. Connectorized: SMA (figures), FC, or not connectorized. Index Profile: Step, others.

Sputter: UNCC. AJA DC sputtering chamber. Material: Gold, Aluminum, Platinum. Pressure: 1-10 mT. Time 10-120 sec. Layer thickness: 2-20 nm.

Laser Annealing: Diode, NgYAG, or Ytterbium fiber laser. Power 0.5-10W. Time: 1-30 min. Fiber tip temperature 200-700C.

Plasma Etching: Fluorine based, CHF₃, SF₆, C₄F₈, CF₄, O₂, Ar. Power: 100-1000W. Pressure 10-100 mT. Time: 3-30 min.

The present subject matter can be embodied in other forms without departure from the spirit and essential characteristics thereof. The embodiments described therefore are to be considered in all respects as illustrative and not restrictive. Although the present subject matter has been described in terms of certain specific embodiments, other embodiments that are apparent to those of ordinary skill in the art are also within the scope of the present subject matter.

What is claimed is:

1. A method of creating an anti reflection structure surface (ARSS) on a fiber optic tip, the method comprising:
providing a fiber optic having a first tip at a first end of the fiber optic and a second tip at a second end of the fiber optic opposite the first end of the fiber optic, each of the first and second tip having an end face;
disposing a layer of masking material on a surface of the end face of one of the fiber optic tips;
exposing the layer of masking material to a light source to form one or more islands of masking material on the surface of the end face of the fiber optic tip; and
etching the surface to provide one or more anti reflection structures on the surface of the end face of the fiber optic tip.

2. The method of claim 1, wherein the masking material comprises a metal.

3. The method of claim 2, wherein disposing the layer of metal on a surface of a fiber optic tip comprises sputtering metal nanoparticles on the surface of the fiber optic tip.

4. The method of claim 2, where the metal is selected from the group consisting of a noble metal and a transition metal.

5. The method of claim 2, wherein the metal layer has a thickness ranging from about 1 nanometer (nm) to about 20 nm.

6. The method of claim 1, wherein the light source is a laser or incoherent light source.

7. The method of claim 6, wherein the light source is selected from the group consisting of a diode laser, a NdYAG laser, a Ytterbium fiber laser, and a tungsten lamp.

8. The method of claim 1, wherein the laser is operated at a power level ranging from about 0.5 watts (W) to about 10W.

9. The method of claim 1, wherein exposing the layer of making material to a laser comprises directing the light source to the layer of masking material from an opposite surface of the surface of the endface of the fiber optic upon which the layer of masking material is disposed.

10. The method of claim 9, wherein exposing the layer of metal to a laser comprises directing the light source to the layer of masking material from the opposite endface of the fiber optic.

11. The method of claim 1, wherein the laser is coupled to one end of the fiber optic.

12. The method of claim 11, wherein the laser is coupled into the opposite end of the fiber from the end of the fiber optic upon which the layer of masking material is disposed.

13. The method of claim 1, further comprising removing the one more islands of masking material.

14. The method of claim 1, wherein the one or more structures each have a preselected dimension based a preselected performance characteristic for the fiber optic.

15. The method of claim 14, wherein the preselected dimension corresponds to a preselected apparent gradient refractive index.

16. The method of claim 14, wherein the fiber optic performance characteristic is operation at a near-infrared wavelength and/or at a mid-infrared wavelength.

17. The method of claim 14, wherein the preselected dimension of the one or more structures is an aspect ratio width: depth of 1:1 to 1:5.

18. The method of claim 14, wherein the preselected dimension of the one or more structures is a width less than or equal to about 500 nm and/or a depth greater than or equal to about 750 nm.

19. The method of claim 1, wherein the fiber optic comprises a material selected from the group consisting of silica, a doped fiber, a gain media fiber, a polycrystalline material, and a single crystal material.

20. The method of claim 1, wherein the fiber optic has a core diameter ranging from about 5 microns to about 1000 microns.

21. The method of claim 1, wherein the etching comprises plasma etching.

22. The method of claim 21, wherein the plasma etching is fluorine based or fluorine and chlorine based.

23. The method of claim 1, further comprising repeating each step on the opposite tip at the opposite end of the fiber optic, to provide one or more anti reflection structures on the end face of the opposite tip of the fiber optic.

24. A fiber optic produced by the method of claim 1.

25. A laser system comprising the fiber optic of claim 24.

26. A fiber optic having a tip having one or more anti reflection structures on an endface of the fiber optic tip, wherein the one or more structures each have a preselected dimension based a preselected performance characteristic for the fiber optic to provide an ARSS on the fiber optic tip.

27. The fiber optic of claim 26, wherein the preselected dimension corresponds to a preselected apparent gradient refractive index.

28. The fiber optic of claim 26, wherein the fiber optic performance characteristic is operation at a near-infrared wavelength and/or at a mid-infrared wavelength.

29. The fiber optic of claim 26, wherein the preselected dimension of the one or more structures is an aspect ratio width: depth of 1:1 to 1:5.

30. The fiber optic of claim 26, wherein the preselected dimension of the one or more structures is a width less than or equal to about 500 nm and/or a depth greater than or equal to about 750 nm.

31. A laser system comprising the fiber optic of claim 26.

32. A system for creating an anti reflection structure surface (ARSS) on a fiber optic tip, the system comprising:
a dispenser for disposing a layer of masking material on a surface of an end face of a fiber optic tip;
a laser for dewetting the layer of masking material to a laser to form one or more islands of the surface of the fiber optic tip; and
a component for etching the surface to provide one or more anti reflection structures on the surface of the fiber optic tip.

33. The system of claim 32, comprising a coupler for coupling the laser to a fiber optic.

34. The system of claim 32, comprising a component for removing the masking material.

35. The system of claim 34, wherein the component for etching the surface and the component for removing the masking material are the same component.

36. The system of claim 32, comprising a controller for operating the dispenser, the laser, the component for etching the surface and/or the component for removing the masking material.
